(19) United States
(12) Patent Application Publication
(10) Pub. No.: US 2007/0081472 A1
(43) Pub. Date: Apr. 12, 2007

(54) System for evolvable network design

(76) Inventors: Mung Chiang, Princeton, NJ (US); Michael Yang, Princeton, NJ (US); Arel Lidow, Norwalk, CT (US); Dick Khan, San Ramon, CA (US); Tonya Chipley Rhodes, Indianapolis, IN (US); Sean M. Crowley, Bay Village, OH (US); Michael Liu, Princeton, NJ (US)

Correspondence Address: BRINKS HOFER GILSON & LIONE, P.O. BOX 10395, CHICAGO, IL, 60610, US

(21) Appl. No.: 11/245,459

(22) Filed: Oct. 6, 2005

(51) Int. Cl. H04L 12/28

(52) U.S. Cl. 370/254

(57) ABSTRACT

A system is disclosed for deploying a network architecture. A first stage and a second stage of the network architecture are deployed. The second stage is deployed from the first stage. A total deployment across the first stage and the second stage of deployment is determined together before the first stage is deployed.

### FIELD OF THE DISCLOSURE

A system, which includes a method and a tool, is used to help determine a network design for a network that evolves in stages over time, such as a telecommunications network for a Hosted Internet Protocol (IP) Communication Service (HIPCS).

### BACKGROUND

In the telecommunications industry, a problem may be encountered in the development and/or deployment of communications networks over time. In one scenario, problems may be encountered in the deployment of a large-scale, national network of media gateways used for Voice over IP (VoIP) services. VoIP is the practice of using an Internet connection to pass voice data using Internet Protocol (IP) instead of using Time Division Multiplexing (TDM) over the standard public switched telephone network. The use of VoIP often allows a remote user to skip standard long distance charges, as the only connection is through an Internet service provider (ISP).

VoIP is being used more frequently to keep corporate telephone costs down but it also demands a well-configured telecommunications network to run smoothly. Because capital expenditures of the telecommunications service provider may be constrained and customer demands may grow over time, hosted VoIP networks may need to be deployed in multiple phases, rather than one single phase. A challenge is how to deploy an early phase network that is evolvable to meet uncertain demands in future phases.

### BRIEF DESCRIPTION OF THE DRAWINGS

FIG. 1 is a block diagram of an exemplary communications system.

FIG. 2 is a flowchart illustrating a use of the system, method and/or tool to deploy a network over multiple stages.

FIG. 3 show a sample output for the three stages.

FIG. 4 is a diagram illustrating a network topology at an exemplary first phase of development.

FIG. 5 is a diagram illustrating the network topology at an exemplary third phase of development.

FIG. 6 is a diagram illustrating the network topology at an exemplary final phase of development.

FIG. 7 is a diagram illustrating the network topology at an exemplary non-optimal final phase of development.

FIG. 8 shows a diagram of an exemplary decision structure.

FIG. 9 is an exemplary spatial map.

FIG. 10 shows an example spreadsheet with a list of inputted data.

FIGS. 11-13 are plots that show the connections between LATAs at each stage of the simulation.

FIG. 14 shows a sample output.

FIG. 15 illustrates a two stage approach of the tool to optimize results.

FIG. 16 is a diagram illustrating a state space reduction process.

FIG. 17 is a block diagram of a general computer system.

### DETAILED DESCRIPTION

A system, which includes a method and tool, is described that aids a service provider in developing and deploying a network over multiple phases or stages. For explanation purposes, the system is described in terms of a telecommunications service provider that implements a hosted telecommunications network for VoIP for HIPCS. The system may be used, however, by users other than telecommunications service providers and for implementations other than VoIP. The system may be used to determine and output deployment costs, and display representations for a multi-phase deployment of the network.

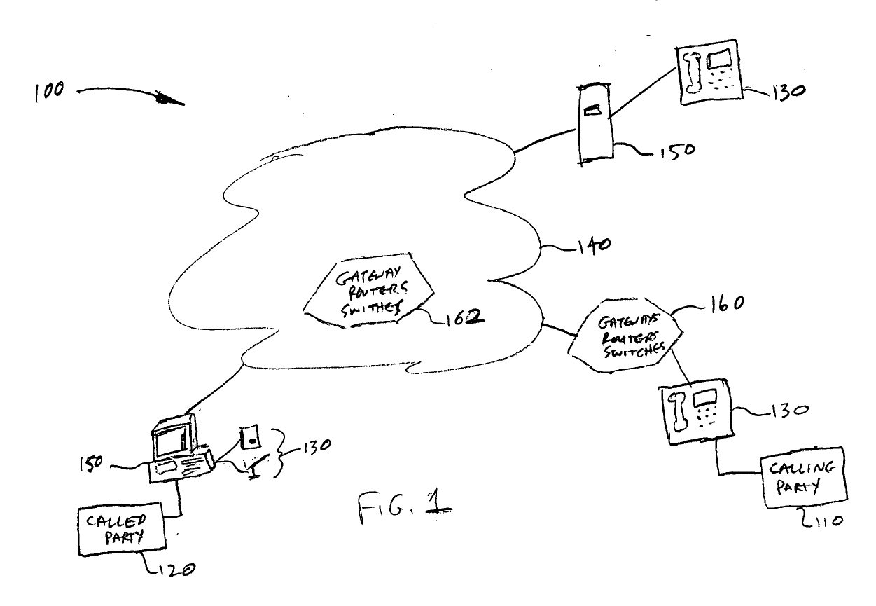

FIG. 1 is a block diagram of an exemplary network system 100, such as a telecommunications network. The network may provide for voice communications using packet-based messages. The system 100 allows for a calling party 110 and a called party 120 to speak to each other in substantially real time. The system 100 includes communication devices 130 that connect to each other over a communications network 140. The communications devices 130 include voice-type communications devices including telephones, such as phones used with landlines, mobile phones, cellular phones, satellite phones, BLACKBERRY's and the like, such as computers having a microphone and a speaker. The communications devices 130 may include hand-held or hands-free devices. The communications device 130 may connect to a processor 150, such as a servers, desk top computers, and laptop computers. The communications devices 130 and the processors 150 may be implemented as one or more physical devices. The communication devices 130 may connect to the network 140 via connections or links 160, such as communication lines, communication gear, gateways, routers and switches. The network 140 may also include such links. The router may include specialized computers and applications that send the packet-based messages between networks, such as between a network of the calling party 110 and a network of the called party 120.

The network 140 includes various types of networks such as local area networks (LANs), wide area networks (WANs), and the Internet. The network 140 may include communication links such as gateways, routers and switches 162. The network 140 may also include signal bearing mediums that may be controlled by software, applications and/or logic. The network 140 may be implemented with a network based virtual private network (VPN or NVPN) service. A VPN is a network that may be constructed by using public wires to connect nodes. The VPN may enable the communication service provider to create networks using a packet-switching network such as the Internet as the medium for transporting data. VPN systems may use encryption and other security mechanisms to ensure that only authorized users can access the network and that the data cannot be intercepted. In a packet-switching network, the voice and non-voice data in a message or file may be broken up into a sequence of packages or packets. The packets may travel through copper cables, fiber optics, microwaves and satellites and the like.

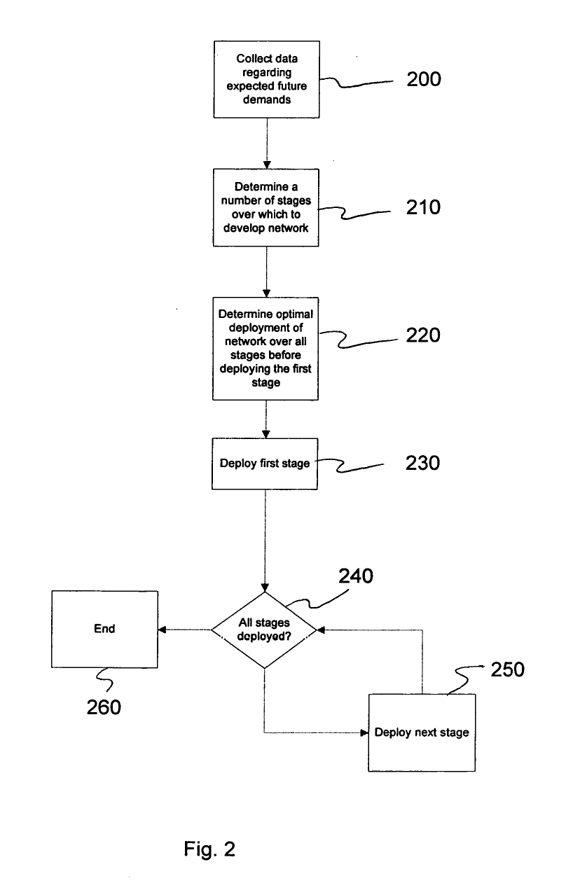

FIG. 2 is a flowchart illustrating a use of the system, method and/or tool to deploy a network over multiple stages. At block 200, the service provider or other user collects data regarding expected future demands for the network 140. A service provider may determine that new systems 100 and/or new networks 140 need to be deployed over time, e.g., to cover future bandwidth demands from users. The service provider may determine that a large number of users are expected after a certain amount of time, such as five years. The service provider may not wish to deploy all in one year the optimal network with respect to year five demand. Due to budget constraints on capital expenditure in each year and gradual growth in customer demands over the years, the entire system 100 or network 140 may be deployed in phases over the five years. At block 210, the service provider or other user determines a number of stages or phases over which to further develop the system 100 and/or network 140.

At block 220, the service provider or other user uses the system, method or tool, such as the one described in more detail below, to determine the optimal deployment of the system 100 and/or network 140 over all of the stages. Determination of the deployment for all of the stages occurs before deployment of the first stage. The system 100 and/or network 140 of some or all stages or phases may contain more than the bare minimum set of switches and links 160, 162 to address the existing customer demands in that phase. Even though some of the phases may be overbuilt or need to be rearranged in future phases, i.e., the deployment of a particular phase may not be optimal, the total cost of the system 100 or network 140 after the final phase is less than if each of the intermediate phases were built to include no more the necessary minimum set of switches and links 160, 162.

By way of example of a minimum built system 100 or network 140, a single aggregator switch may be adequate to address all the demands in phase one. But if only one aggregator switch is deployed and all geographically diverse users are connected to this switch, then when the number of users in each sub-region becomes big enough to warrant a dedicated switch, the users connected to the distant switch deployed in phase one may be traversing an unnecessarily long and expensive link. By looking ahead into future phases, deploying multiple switches 160, 162 in phase one may be more cost-effective. The resulting maintenance and inflation costs may be more compensated for by a more cost-effective network topology at the end of the last phase. The amount of overbuilding of the system 100 and network 140 to be allowed in each phase is determined, beyond covering the existing demands and in anticipation of growth in the number of users and demands per user in future phases, in view of architectural, technological and budgetary constraints.

At blocks 230, 240 and 250, the stages of the system 100 and/or network 140 are deployed over time, from the first stage to the last, until all of the stages are completed, at block 260. The first stage is a stage in terms of being the first stage developed using the system, method and/or tool. The first stage may or may not be the actual first stage or phase of the system 100 or the network 140. The system, method and tool may be used at any stage of development of the system 100 and/or network 140, such as on an existing or non-existing system 100 and/or network 140. The second stage may or may not utilize some or all of the communication equipment that was used in the first stage.

The system, method and/or tool may be used for determining a cost effective way to deploy a system 100 or network 140 over the multiple phases or stages. The system, method and/or tool may take into account expense-revenue tradeoff considerations, constant parameters and optimization variables, such as discussed below. The system, method and/or tool may be used to strike a preferred balance between allowing under building and overbuilding in each phase or stage.

FIG. 3 shows a diagram of an exemplary decision structure for deploying the network over stages as visualized as a trellis diagram 300 of nodes 302 and edges or links 304. A tree structure of the trellis diagram 300 is shown for two stages 306,308, with nine paths 310 to the final stage. The paths 310 may be chosen that provides optimal results, such as the lowest overall cost, for the deployment from stage one through stage three.

A dynamic programming principle may be used to determine an optimal way to deploy the network over stages. The dynamic program may be used to solve the sequential decision problems of the multiple phase network deployment. Dynamic programming includes the computation of optimal solutions to a series of optimization problems where the problem parameters of later problems depend on the solution of earlier problems. The dynamic program is used to find optimal or near-optimal values for non-linear functions. An analogy for a dynamic program is throwing darts at a target. Every point on the target may have some number attached to it, but the numbers cannot be seen. With three darts to throw, the goal is to minimize the sum of the three numbers that the darts hit. One way to approach this problem would be to throw all three darts at the board at the same time and remember the set of coordinates on the target for the throw which resulted in the minimal sum. In HIPCS terminology, this approach is the equivalent of randomly creating access and server complexes and pricing each to find the one with the minimum cost. If the target is large, however, implementing this approach may not be practical, e.g., take an excessive amount of time to implement.

In FIG. 3, using the dart example, each circle represents one dart throw, except for the leftmost circle 320, which is the initial state (sum=0). With the dynamic program, a user takes aim, throws the three darts at the board, assuming that each throw represents the first in a series of three, and notes the number associated with each dart. Then the user repeats this process two more times, and finds the best resulting “path” (there are 3*3=27 paths to choose from). Because states are chosen dynamically as a function of past states, the approach is referred to as a dynamic program. The state of future implementations determined as a function of the previous states, before the previous states are actually implemented.

In the context of a telecommunications system, a node 302 may represent a total configuration of a network and the edges 304 may represent possible evolutions to the node 302. Nodes 302 may also represent other objects, such as routers, switches and gateways within a network. The edges 304 may represent costs, such as startup cost per mile and/or maintenance cost per mile. Each column may be indexed by κ phases of the network deployment. Each node 302 in the trellis may represent a physical layout state, including customers, switches and links, and each edge represents a possible transition between states. Incremental network deployments update a state at phase κ to another one at phase κ+1. There may be an edge cost between two states, which is the sum of the costs required to build and maintain infrastructure minus the customer profits gained at the time κ. If it is not possible to reach a state from another one, the cost is infinite. The goal for the service provider may be to tailor the stages or phases of development of the network to meet a demand profile. The demand profile may be to minimize or optimize costs across the stages, however, other demand profiles may be met, such as to control the number of network connections from stage to stage.

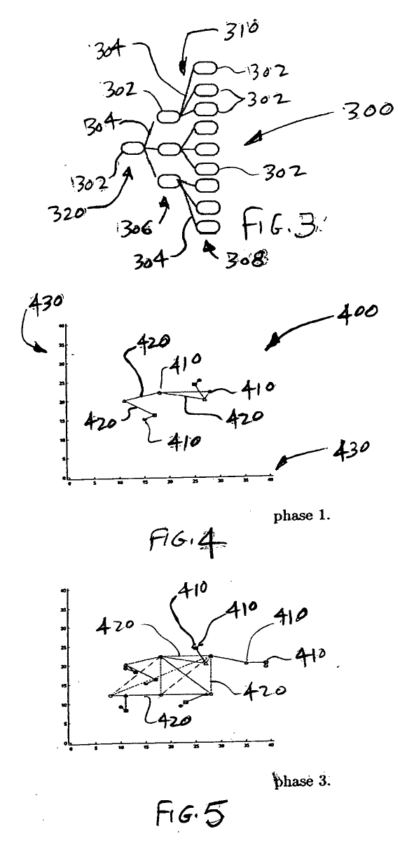

FIGS. 4-7 illustrate an example of a medium size network deployment scenario over multiple phases. In FIG. 4, results of the tool may be visualized by a network topology diagram 400. The network may be represented by nodes 410, such as switches, gateways and routers, and connections 420, such as fiber optic, copper, cellular and cable, in the diagram 400. The diagram 400 includes two axis 430. The two axes 430 may be indexed by a number, such as from zero to forty, to show the distance between nodes. Each diagram represents a phase of development.

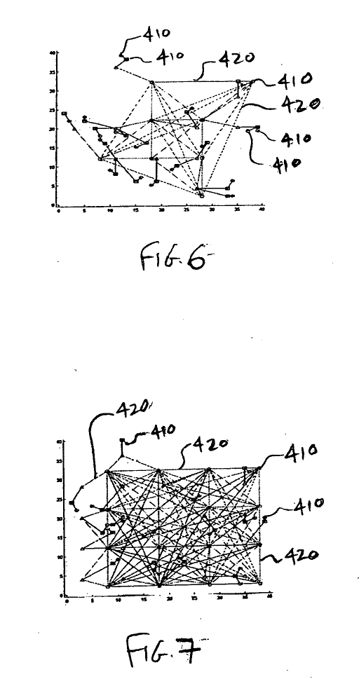

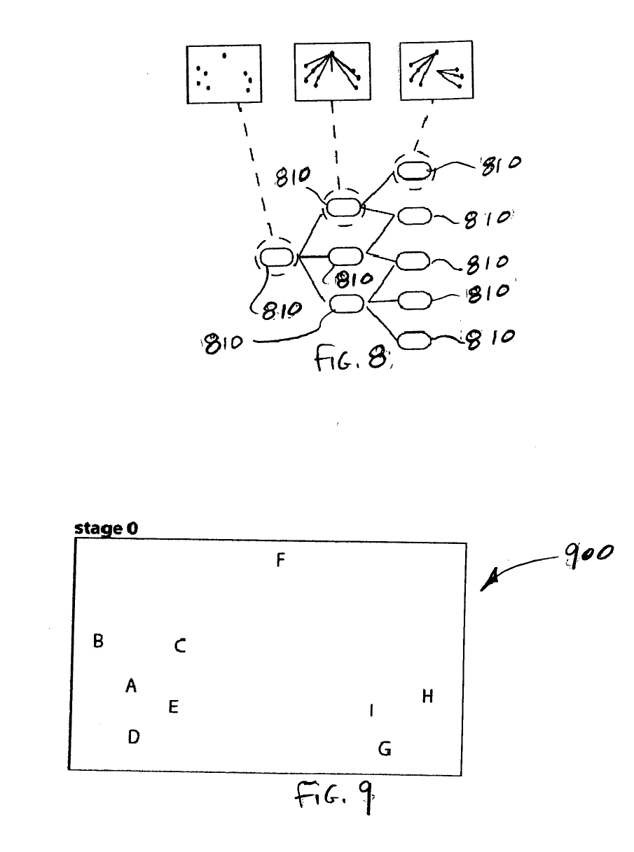

The final state is not predetermined, e.g., the example is for a non-fixed-final-state. In other scenarios, the final state is determined. For this example, the final state becomes a by-product of the construction of the trellis diagram from phase one to phase ten. FIGS. 4-6 show the network topology at phases or stages 1, 3 and 10 in the optimal evolution path as computed by the tool. FIG. 7 shows the final phase network topology in one of the suboptimal evolution paths. Compared to FIG. 6, the network of FIG. 7 is much more complex and includes many more nodes and connections between the nodes. The network topology of FIG. 7 would not have been developed if the entire deployment had been carried out in a single phase. Yet this development could be the result of trying to minimize the costs at each phase separately instead of analyzing the network as a multi-phase deployment. The system, method and tool confirms and quantifies the intuition that striking a balance between deploying the most cost effective solution in each phase and anticipating the future demands and determining the cost effective solution over multiple phases. The multi-phase deployment may be more cost effective even though the cost intermittent phases may not be the most cost effective solution for that particular phase. Such a solution can enhance network efficiency in the end phase. In this example, the deployment cost for the optimal evolution path is 3797 units whereas that for the suboptimal ones can be as high as 28634 units, representing savings in deployment costs when viewed over all the phases.

A service provider may wish to use the system, method and/or tool to obtain the most profitable network deployment throughout a determined number of phases or stages. The number of stages may be determined based on market forecasts on customer locations and band-width demands. The estimates may be based on accurate customer polling, and sometimes inaccurate polling, in which case the tool computations may be run on different data sets generated from different customer polling results. The system, method and tool may be used before network deployment, and incorporate a variety of topological and technical constraints, as discussed in more detail below. The system, method and tool may also be used for a network that has already been deployed in order to determine an optimal path forward based on the current state of the network and forecasted growth.

FIG. 8 shows a diagram of an exemplary decision structure used with the tool. Like the dart example, the tool may create a tree structure, also known as a trellis, of states. Each state may represent a network configuration. Each block 810 represents one state. For the states that are circled, in the figure the three top-most states on the tree, a small snapshot is shown of what the state contains on a spatial map. The leftmost state is the root of the tree. The root contains the initial conditions for the problem. In this example, there are eight LATA spread over a map, none of which are remotely served. As the simulation progresses, “children” states are generated from the nodes in the previous stage. One level of the tree represents a stage.

The trellis may be built in various ways. One way to build the trellis diagram depends on if the final network state configuration is known. If the final network state is known, a trellis diagram may be established before running the recursive dynamic programming algorithm. The algorithm can start from the known final state and determine the network topology over the different stages based on the customer demands at the final phase. Possible states in earlier phases are then constructed from phase N−1 to phase one. This approach may be particularly useful if a user knows that demand will remain constant after a specific amount of time. For example, if a network provider expects the majority of customers to arrive over a period of five years, the network provider may determine an optimal final configuration of the network five years from the time of planning, and then use the tool to determine an optimal building schedule over the five years to achieve the final configuration.

Alternatively, the program can be run based on the known existing state of the network and an undetermined final state. All the possible states at phase κ+1 from the states at phase κ can be constructed. The trellis diagram may be constructed based on all the allowed control strategies. The first approach may generate substantially fewer states but is not as general as the second approach. The two approaches represent different tradeoffs between computational tractability and dynamic programming optimality. In both cases, due to budget constraints, a limited segment of the network 140 may be constructed beyond meeting the requirements from existing customers.

Costs or the edges in the trellis diagram are assigned. Each cost may include multiple parts: such as expense and revenue. Expense includes both one-time building expense, incurred only at the phase of building the switch or link, and recurrent operating expense, incurred in all the phases after the construction for each type of switches and each type of links. Revenue includes both one-time customer signup revenue and recurrent customer payment revenue.

In general, minimizing costs in a phase runs the risk of cornering future phases into highly sub-optimal design space, since once an end-to-end connection is established, it cannot be torn down cheaply, if at all, since there may be active traffic through it. Tearing down such a connection may involve service interruption. An optimal evolution path strikes a balance between building ahead of time in anticipation of customer growth and avoiding overbuilding to reduce unnecessary costs. Once the trellis diagram is constructed, standard dynamic programming recursion may be applied to the trellis to determine a most cost effective path. Since the state-spaces are deterministic and finite, finding optimal network evolution over an evolution of N phases is equivalent to computing the minimum cost path across the trellis diagram.

The system, method and/or tool may be used to solve a sequential decision problem of multi-phase network deployment. The system, method and/or tool takes into account a variety of network architectural constraints and constructs a trellis diagram. The system, method and/or tool runs dynamic programming recursive computation on the trellis diagram to search for an optimal, e.g., lowest phase one to last phase cost, network deployment through all phases. The system, method and/or tool may output a computed optimal multi-phase deployment solution visually on a sequence of network topology graphs, one graph per phase, and output the minimized total deployment cost, as described in more detail below.

In another example, the tool may assists in the design of HIPCS network being deployed over multiple stages. Because the number of deployment scenarios may be so large, the tool may be used to consider scenarios which may not be initially obvious to a user. By considering complex scenarios, the tool may be able to reduce network deployment costs by more than 10%. An example of an implementation with a larger deployment follows.

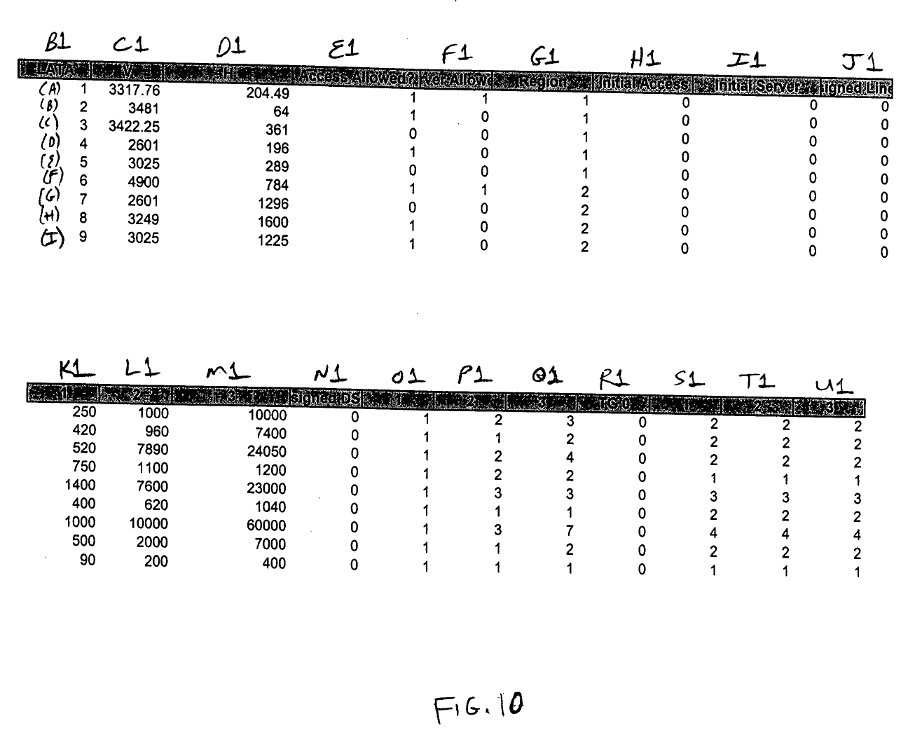

FIG. 9 is an exemplary spatial map 900 containing nine local access and transport areas (LATAs), labeled A-I, before deployment of a HIPCS network. A LATA is a geographical area defining local telephone services. Any call originating and terminating within a LATA may be handled by the local telephone company (Local Exchange Carrier LEC), but calls between LATAs may be handled by long-distance service providers (Inter-Exchange Carrier IXC). The map 900 contains the nine letters A-I, each representing a LATA. In this example, the service provider decides to deploy a HIPCS network over three stages in order to meet forecasted demand.

The dynamic programming state data structure may take into account various considerations such as the location coordinates of the switches at phase κ, location coordinate and bandwidth requirements from each user, and the pair of switches connected by each link. The control data structure may take into account various consideration such as new switches and new links, e.g., the connections, such as fiber optic, copper or cellular, between the links. Together with the new customers' data structures, the control data structure updates the state data structure by conducting constructions. Constructions are done either randomly, or using heuristic measures, such as network density, to determine states which are likely to produce near-optimal configurations over time. Given a current state of the network and the control decisions, changes may be deployed in the control decisions (e.g., building a link, adding a router) and the new state of the network is obtained.

In addition to budget constraints per phase, the control spaces may be constrained by the required network architectures. For example, a constraint is that each type of switch may only be built within a certain subset of the points on the network deployments map. In order for a link to be built between switches, the switches at the end points have already been deployed and there is a vacant port on the switches. The number of ports on each switch is one of the parameters that may be specified, each with a different maximum data rate that it can support. All topological constraints needing network deployment may be satisfied, e.g., dual-homing from an aggregator to a core and full mesh of the nodes within the core. Dual-homing refers to an arrangement where one router is connected to two upstream routers for redundancy and protection purposes. Full mesh refers to each node being connected to every other node in the network. Furthermore, the tool may require that each customer must be connected to a switch within a specified radius of r units with sufficient bandwidth support. The system, method and/or tool may use a recursive function to determine if the network elements are connected according to the rules.

Exemplary forecasted line quantities associated with the demand are depicted in Table 1.

TABLE 1

| | A | | | | | | | | |
|---|---|---|---|---|---|---|---|---|---|
| Stage | (assigned lines) | B | C | D | E | F | G | H | I |
| 1 | 250 | 420 | 520 | 750 | 1400 | 400 | 1000 | 500 | 90 |
| 2 | 1000 | 960 | 7890 | 1100 | 7600 | 620 | 10000 | 2000 | 200 |
| 3 | 10000 | 7400 | 24050 | 1200 | 23000 | 1040 | 60000 | 7000 | 400 |

For each stage, Table 1 lists the forecasted lines per LATA. Assuming that every LATA is served by a Media Gateway (MGW), and that a LATA can only be served by one of any of the nine other LATAs, an optimal three-stage deployment path may be determined by the tool. By looking at the map 600, it would seem that F is the best LATA to serve all others because F is the most centralized.

The price of this scenario would be a little over $500,000, given the network cost parameters in the following table. For this example, the service provider may assume that there is that there is no MGC server complex because the existence of a server complex may have little impact on the solution of the tool.

TABLE 2

| Access | | | | | |
|---|---|---|---|---|---|
| Office | | | | | |
| Non- | | Media | | | |
| recurring | | Gateway | | | |
| (i.e. one | Media | (per | DS3 (per | | |
| time) cost | Gateway | subscriber) | mile) | DS3 | DS3 |
| (NRC) | (NRC) | (NRC) | (monthly) | (NRC) | (monthly) |
| $1481481.48 | 515555.56 | 21.60 | 2.49 | 888.89 | 1555.56 |

The DS3 is a digital signal level 3 high-speed line capable of delivering 44.7 Mbps of data in both directions. The DS3 is typically a private line service designed for point-to-point communications. Other types of connections, however, can be used with the tool. As described in more detail below, the tool may be used to optimize the deployment of this network, resulting in a final cost of less than $400,000, or a 20% decrease in expected costs.

FIG. 10 shows an example spreadsheet with a list of inputted data. The spreadsheet includes twenty columns of data (B1:U1) and a column (A) that may be used for adding comments to the input file. The system, method and/or tool may use a program, such as a spreadsheet, such as MICROSOFT EXCEL, to gather the input from users and to display outputs to the user. Other programs that can collect and/or arrange and display data may also be used. The spreadsheet may contain all of the LATA-specific information that the tool will use. A description of the contents of each column follows:

TABLE 3

| Excel | | |
|---|---|---|
| Col- | | |
| umn | Column Name | Content Description |
| B | LATA | A number which uniquely identifies each |
| | | LATA. The numbers in this column increase |
| | | sequentially with no gaps (e.g. 1, 2, 3, 4, 5; not |
| | | 1, 3, 2, 4, 5). |
| C | V | Vertical coordinate of LATA |
| D | H | Horizontal coordinate of LATA |
| H | Access Allowed? | 1 if LATA can host an access office; 0 |
| | | otherwise |
| F | Server Allowed? | 1 if LATA can host a server office; 0 |
| | | otherwise |
| G | Region | A number which identifies the LATAs |
| | | region |
| H | Initial Access | The LATA number (from column 1) of the |
| | | LATA which initially serves (via MGW) this |
| | | LATA; 0 if not currently served |
| I | Initial Server | The LATA number (from column 1) of the |
| | | LATA which initially serves (via MGC) this |
| | | LATA; 0 if not currently served |
| J | Assigned Lines 0 | Number of initial assigned lines in this |
| | | LATA |
| K | 1 | Assigned lines in stage 1. |
| L | 2 | Assigned lines in stage 2. |
| M | 3 | Assigned lines in stage 3 (If there are more |
| | | than three deployment stages, then additional |
| | | columns are inserted here. |
| N | Assigned DS1s 0 | Number of initial assigned high speed line |
| | | DS1's in this LATA. |
| O | 1 | Assigned DS1's in stage 1 |
| P | 2 | Assigned DS1's in stage 2 |
| Q | 3 | Assigned DS1's in stage 3 |
| R | TG 0 | Number of initial trunk groups (TG's) in this |
| | | LATA |
| S | 1 | TG's in stage 1 |
| T | 2 | TG's in stage 2 |
| U | 3 | TG's in stage 3 |

Another spreadsheet or other input device may contain the values of simulation constants. These include the network cost parameters referenced in Table 2, parameters which describe the scenario being modeled, and other parameters that affect the execution process of the tool itself. A description of the constants follows:

TABLE 4

| | |
|---|---|
| N | The number of deployment stages. |
| AC_greenfield | The cost of building the first access configuration in a |
| | LATA. |
| SC_greenfield | Cost of building the first server configuration in a LATA. |
| SC_sub | Cost to serve one additional customer from a server |
| | configuration (non-recurring) (NP) |
| SC_increment | Cost to increment the capacity of a server configuration by |
| | max_sc_subs (NP) |
| SC_conversion | Cost to convert an access configuration into a server |
| | configuration (NP) |
| MGW_ifc | Cost to build a new Media Gateway (NP) |
| MGW_sub | Cost to serve one customer from a MGW (non-recurring) |
| | (NP) |
| DS3_mile | Per-mile maintenance cost for a DS3 line (recurring |
| | yearly) (NP) |
| DS3_nrc | Initial cost to build a DS3 line (NP) |
| DS3_mrc | Monthly recurring cost for a DS3 (NP) |
| interest_rate | Discount rate used in calculating net present value |
| | (set to 0 if no discount rate) (NP) |
| Max_size | Maximum number of children any state can have (PE) |
| Max_mgw_subs | Maximum capacity of a MGW (NP) |
| max_sc_subs | Maximum capacity of a server configuration (NP) |
| sr_high | Percentage of max_size children which have high costs that |
| | should continue to next stage. |
| | Sr_high+sr_mid+sr_low |
| | MUST equal 1. (PE) |
| sr_mid | Percentage of max_size children which have medium costs |
| | that should continue to next stage (PE) |
| sr_low | Percentage of max_size children which have low cost that |
| | should continue to next stage (PE) |
| Density_self | The density of a LATA at stage t is calculated as |
| | ${d}_{i , t} = ( {\sum }_{j \neq i} \frac{{C}_{j , t}}{{dist}_{ij}} ) + density\_self \cdot {C}_{i , t} ,$ |
| | where C_{i,t} is the sum of all customers which will arrive at |
| | LATA i between (and including) stage t and the last stage, |
| | and distᵢⱼ is the distance between LATAs i and j. LATA |
| | densities are a factor in determining the optimal MGW server |
| | for a LATA. By making density_self larger, LATAs which |
| | have a lot of customers are more likely to serve other |
| | LATAs. (PE) |
| servefac_dens | The “servefactor” is a metric which rates how optimal a |
| servefac_dist | certain server-servee link is. It is calculated as |
| servefac_cap | sf_{ij,t} = servefac_dens · log(d_{i,t}) − servefac_dist · log(distᵢⱼ + 1) + |
| | servefac_cap · capacity_{i,t} |
| | where LATA i is serving LATA j and capacity_{i,t} is the |
| | capacity of LATA i at stage t. (PE) |
| Changefac_linklen | “Changefactor” is a metric which rates how much a LATA |
| changefac_density | would benefit from being rehomed at stage t. It is calculated |
| changefac_numserve | as |
| | cf_{i,t} = changefac_linklen · log(linklenᵢ) + |
| | \changefac_density · log(d_{i,t} + 1) − |
| | changefac_numserve · log(c_{i,t} + 1) |
| | where c_{i,t} is the number of customers served by MGW's in |
| | LATA i at stage t. |
| | (PE) |
| max_children | Number of children states that are considered for each parent |
| | state. This is different from max_size because it is the |
| | number of children before any state-space reduction. (PE) |
| Change_dist | An array, where the i^{th} entry corresponds to the percentage of |
| | max_children states which will have i changes. So, if |
| | change_dist = [.5 .5], then .5*max_children will have one |
| | rehome, and .5*max_children will have two rehomes. Note |
| | that the case of no changes is always considered as well. The |
| | values of the change_dist array should sum to 1; otherwise, |
| | you may get memory errors. (PE) |
| use_genetic_alg | If 1, then the BND Tool will run its result through a genetic |
| | algorithm to further optimize the minimum-cost path. This |
| | step is important because the purpose of the BND-Tool is to |
| | find near-optimal solutions; the genetic algorithm serves as a |
| | hybrid function which further refines the results. If 0, then |
| | genetic algorithm will not be run. (PE) |
| genetic_generations | The number of generations the genetic algorithm will go |
| | through before stopping. A higher value will take longer to |
| | compute but will get a better solution. It is recommended that |
| | this value be greater than 2000. (PE) |
| view_genetic | If 1, then shows the real-time convergence plot of the genetic |
| | algorithm. Otherwise, 0. |
| | (PE) |
| display_best_path | If 1, then plots the optimal evolution after all optimizations |
| | are completed. (NP) |
| Output_to_map | If 1, then plots evolution on a map of the United States |
| | (display_best_path must be 1 for this parameter to be |
| | relevant). (NP) |

The listing NP designates a network planner and PE designates a programming expert. To execute the simulation, the tool may be run from the command line of a disk operating system (DOS) prompt. An example command line includes END.exe input.xls output.xls.

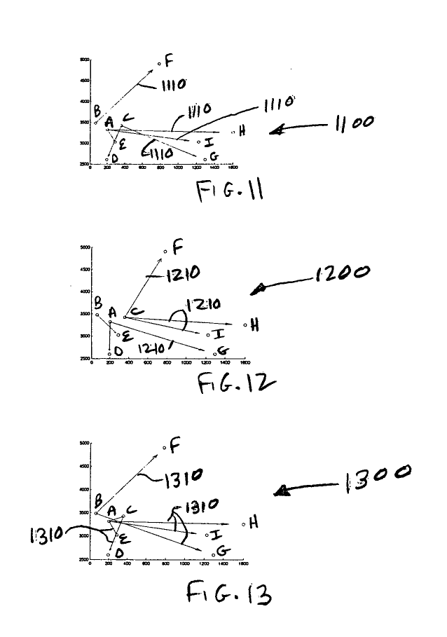

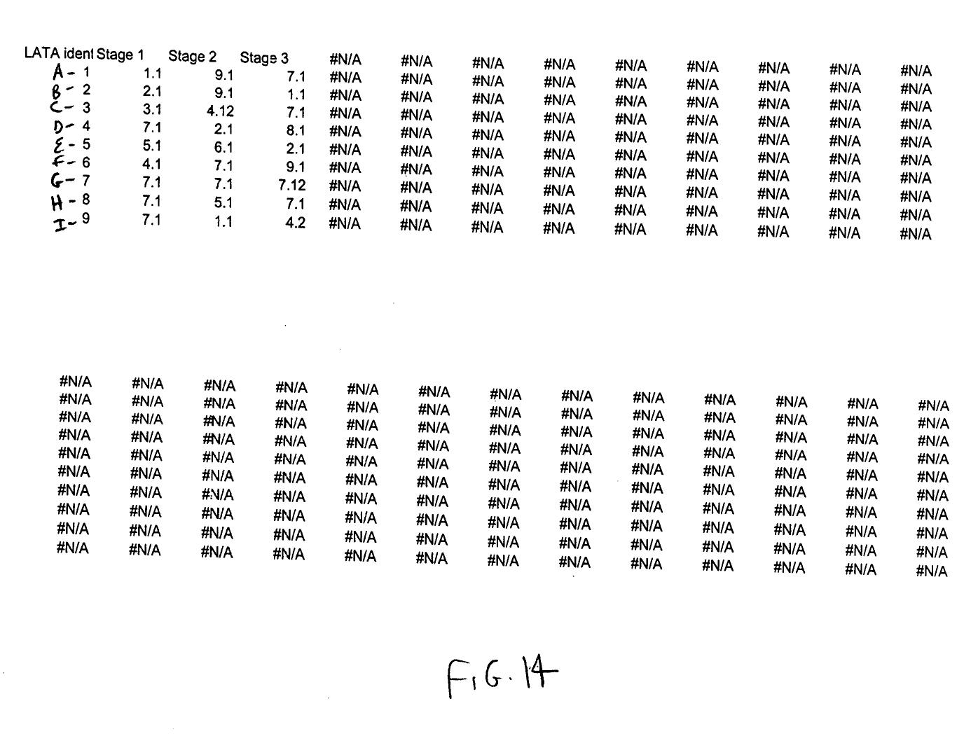

FIGS. 11-13 are plots that show exemplary connections between LATAs at each stage of the simulation. The plot 1100 shows the connections 1110 after stage 1. The plot 1200 shows the connections 1210 after stage 2. The plot 1300 shows the connections 1310 after stage 3. As the simulation finishes, the set of plots may appear showing the user the optimal evolution at each stage. In this example, the optimal path generated by the tool is different from what a user might otherwise have chosen without the tool (e.g.—serving everything from F). Without the tool, the user may have tried to optimize the network from stage to stage, but not considered optimized the network, such as by considering a total deployment cost across all stages of deployment, before implementing the first stage.

FIG. 14 show a sample output for the three stages. The output file may include a EXCEL spreadsheet that is updated when the simulation is run. This sheet contains the information needed to reconstruct the access complex states of the minimum-cost evolution for each stage of the simulation. For this example, the sheet utilizes four columns. The first contains the LATA number, as specified in the input file. The second column holds the links for the first stage of evolution. The links represent the physical connections between the LATAs or nodes in the network. Each row in this column is a number which specifies the LATA that serves, such as via a Media Gateway, this LATA during the first stage, and the number of elements (e.g., Media Gateways) within the serving LATA serving other LATAs, which is depicted after the decimal point. The decimals denote which network elements, in this case the Media Gateway's, are serving this LATA from within the serving LATA. The third and fourth columns hold the same type of data for the second and third stages. If there were more stages, then additional columns would be added. For example, if there were 6 stages, then there would be 7 columns total. The tool may also output the number of MGWs in each LATA at every stage.

For a more complex example than the one earlier, a user decides to model a HIPCS network over the entire continental U.S. using more LATAs, such as seventy-eight LATAs, over six deployment stages. Because this simulation is on a larger scale than the previous example, some of the constants may be changed. The following table highlights which constants may be changed and a reason for the change:

| | |
|---|---|
| change_dist | The change_dist array's length was made shorter because, unlike the |
| | simple example, most of the network's structure has already |
| | been established in the initial conditions. So, changing the |
| | conditions drastically is not likely to result in a decrease |
| | in cost. This simulation therefore focuses on small changes |
| | to the existing infrastructure instead of undertaking |
| | massive building. As an experiment, the user may run the |
| | program with different change_dist and observe the |
| | differences to the output. The user may notice that as more |
| | changes are considered, the results tend to get worse. |
| output_to_map | Changed from zero to 1 in order to view the output on a map of the |
| | continental US. This should only be zero if any LATAs |
| | are not in the continental US. |

Some constants may affect the memory usage or running time of the tool. Specifically, there are three such constants: max_size, max_children, and genetic_generations. The following are the tradeoffs of each:

| | |
|---|---|
| Max_size | This parameter sets the number of states to be carried on from |
| | one stage to the next. The greater this constant is, the more |
| | possibilities are considered in the dynamic program, and hence |
| | the better the solution may be. However, this |
| | parameter may affect memory usage of the computer. As stated |
| | before: The user may keep max_size\hat{ }N * |
| | max_children less than 100,000 to avoid memory errors. |
| Max_children | This parameter sets the number of states to be considered, but not |
| | to be carried onto the next stage. It has less of an affect |
| | on memory than max_size, but it can cause memory errors |
| | set too large. |
| Genetic_generations | This parameter sets the number of populations to be |
| | considered in the genetic algorithm described below. There is no |
| | memory constraint on this parameter, only a time |
| | constraint. The user may set this parameter to be large |
| | (>2000) if possible. |

FIG. 15 illustrates a two stage approach to optimize results of the system, method and/or tool. The system, method and/or tool may use a known genetic algorithm to boost the results from the dynamic program. The two-phase approach is not necessary; however, the results of the tool may be improved when the results of the dynamic program are further optimized. A reason for this effect is that the dynamic program produces a result that is likely to be relatively accurate, but can still be improved upon by searching for nearby results. More specifically, the optimal output from the dynamic program may be a deployment path that has good properties. These properties, like network density, are defined by modifying the heuristic constants, which are discussed below. The output from the dynamic program is likely to have a good structure, and have a much lower cost than an average randomly-generated deployment path. There may be, however, some deployment paths similar to the first-phase generated paths that have a lower cost than the first-phase generated paths.

The genetic algorithm may be used to explore these similar paths. The algorithm works by creating a large population of deployment paths containing slight changes from the original path. The deployment paths in the population which result in the greatest decrease in costs are carried on in the next generation, and more paths are generated from these paths, each with slight modifications. The paths which result in increasing costs eventually are removed. The genetic algorithm makes slight modifications to an existing path in order to find paths which are similar but have some characteristic which enhances cost. The MATLAB program described above includes a built-in genetic algorithm toolbox.

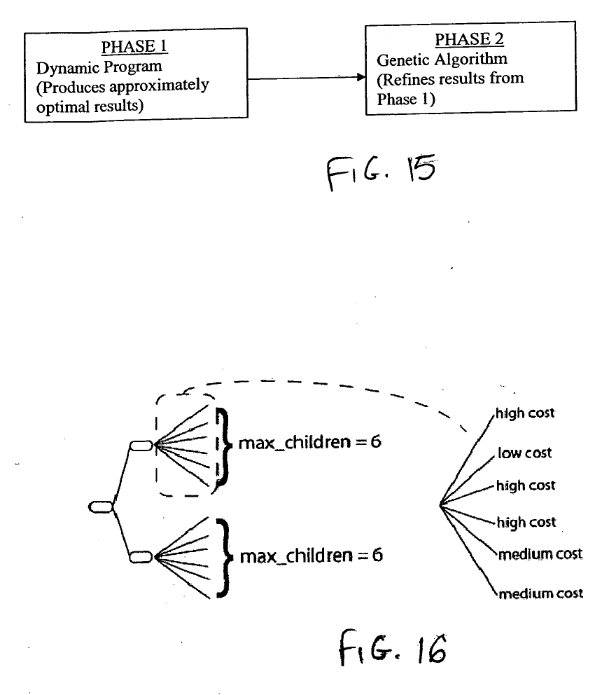

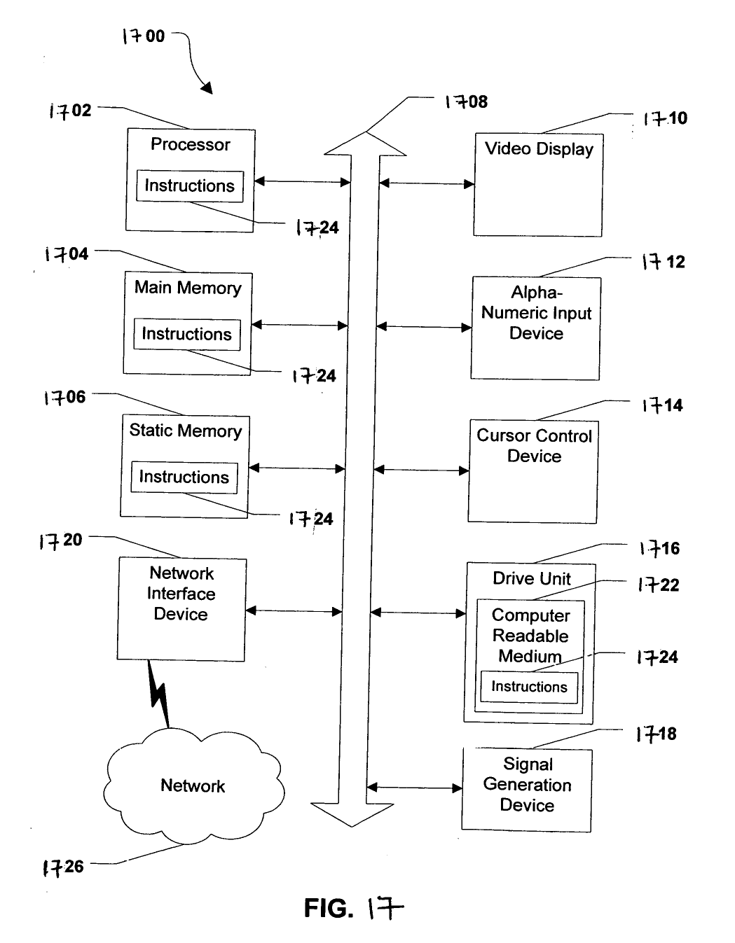

FIG. 16 is a diagram illustrating a state space reduction process. The maximum number of children is set to six. Other maximum amounts of children may be used, as described below.

In practice, not all possible states may be considered in the trellis diagram. Even with only nine LATAs, the number of states in any one stage would be 9ˆ9 states. Thus, for a three-stage simulation, there would be (9ˆ9)ˆ3=5.8e25 paths to consider. If it only took one one-millionth of a second to compute the cost of a state, it may still take 58 billion seconds (about 7×10ˆ23 hours) to find the single best evolution.

To bring the number of states, known as the state-space, down to a reasonable size, the tool may use several techniques to choose which states to discard and which to keep. A first technique is to limit the number of children states that can be generated from any existing state. To set the limit of the number of children states that can be generated, change the max_children parameter described above. If the tool is creating the children for the third stage, and there were fifty nodes in stage 2 and max_children is set to five, then the total number of children generated for the third stage is 50*5=250.

Not all of these children may be carried on to stage 3. The tool may perform another state-space reduction. The user may choose max_size children from each set of children generated by each node to continue based upon their cost distributions.

A third type of state space reduction may occur when the tool generates the children of a node. As mentioned before, the maximum number of children for a node may be determined by the user set variable max_children. However, max_children usually is smaller than the total number of possible states in order to avoid running out of memory. In order to choose which states should become children, the tool may use a set of metrics to decide which states are most likely to yield good results. The user may change several constants which are used to calculate these metrics, thereby changing the types of children states which tend to be propagated. Below is a table describing each constant and how changing it affects the types of children:

| | |
|---|---|
| Density_self | Increasing this factor makes it more likely that LATAs which |
| | have a lot of assigned lines serve themselves and other |
| | LATAs. |
| Servefac_dens | Increasing this factor means that the more dense LATAs |
| | (e.g. - LATAs which have a large number of assigned lines |
| | and a lot of other LATAs nearby) are favored to serve |
| | other LATAs. |
| Servefac_dist | Increasing this factor means that the distance between two LATAs |
| | becomes more important in deciding which LATAs |
| | become servers (the higher it gets, the shorter the |
| | distances becomes). |
| Servefac_cap | Increasing this factor means that LATAs which have free |
| | capacity are favored as serving LATAs relatively more than |
| | LATAs which have less free capacity. The downside of |
| | making this factor large is that less rehomes occur. A LATA |
| | rehome occurs when the LATA (or node) that serves |
| | it changes to a new LATA (or node). |
| Changefac_linklen | In deciding which LATAs to rehome, the tool may take into |
| | account the length of each LATAs link. The higher this |
| | factor is, the more the link length accounts for |
| | whether a LATA should be rehomed. |
| Changefac_density | Increasing means that LATAs with higher densities are |
| | rehomed more often. |
| Changefac_numserve | Increasing means that LATAs which are already serving |
| | customers are less likely to be rehomed. |

The following is an outline of algorithms that may be used to find optimal children. A matrix may be created called hslist with the dimensions (# of LATA)×(#of LATA). When it is completely filled in, hslist, the jth column of hslist will contain an ordered list of LATAs which are approximately the most suitable to serve LATA j. The LATA at the top of the jth column of hslist is the most suitable to serve LATA j. For each LATA j, a matrix sf is created with the dimensions (# of LATA)×2. The first column of sf contains a list (from 1 to # of LATA) of all LATAs. The second column of sf is filled in using the following equation:
sf_{ij,t}=servefac_{—}dens·log(d_{i,t})−servefac_{—}dist·log(distᵢⱼ+1)+servefac_{—}cap·capacity_{i,t} Equation 1

where di,t is the density of LATA i at the current stage, distij is the distance between LATAs i and j, and capacity i,t is the capacity of LATA i at the current stage.

The value sf is sorted by its second column in descending order. Then the first column of sf is transferred into the jth column of hslist. A matrix called cf may be created with the dimensions (# of LATA)×2. The first column of cf may contain a list (from 1 to # of LATA) of all LATAs.

The second column of cf is filled in using the following equation:
cf_{i,t}=changefac_{—}linklen·log(linklenᵢ)+changefac_density·log(d_{i,t}+1)−changefac_{—}numserve·log(c_{i,t}+1) Equation 2

where linkleni is the length of the link serving LATA i, and ci,t is the number of customers served by LATA i at the current stage.

The value cf is sorted by its second column in descending order. Then truncate the second column of cf. You are now left with a sorted list of which LATAs would probably benefit the most from a rehome (the LATA at the top of the list will benefit the most from a rehome, the one at the bottom will benefit the least).

A matrix hsselect may be created with dimensions max_children x 2. The first column of hsselect may be filled in by selecting the first max_children entries from cf. The second column of hsselect may be filled in with the values 1 to max_children. The first column of hsselect may be used to select the column of hslist, and the second column of hsselect may be used to select the row of hslist. If the entry ij of hslist is selected, LATA j are rehomed to LATA i.

The dynamic programming of the system, method and/or tool may be implemented with a program such as MATLAB version 7.0 or greater, or the like. MATLAB is manufactured by MATH WORKS, INC., and can be purchased from the website at Mathtools.net. The dynamic programming may be implemented as a program run with software, firmware, hardware, or a combination thereof, with a processor. The dynamic programming may include operable routines stored in a memory. The memory refers to any computer storage mechanism that supports a magnetic storage medium, an optical storage medium, an electronic storage medium, or any other suitable storage medium, as described in more detail below. Dedicated hardware implementations including, but not limited to, application specific integrated circuits, programmable logic arrays and other hardware devices can likewise be constructed to implement the tools described herein.

Referring to FIG. 17, an illustrative embodiment of a general computer system is shown and is designated 1700. The computer system 1700 can include a set of instructions that can be executed to cause the computer system 1700 to perform any one or more of the methods or computer based functions disclosed herein. The computer system 1700 may operate as a standalone device or may be connected, e.g., using a network, to other computer systems or peripheral devices. The dynamic program may be executed on a computer, such as computer system 1700, with at least 400 MHz processor, 512 MB random access memory (RAM) and 1 GB free hard disk space, or more preferably a 1 GHz processor, 1 GB RAM and 5 GB free hard disk space. Suitable operating systems include MICROSOFT WIN 2000, NT and DOS. Other operating systems may be used such as UNIX or LINUX, and the program may be invoked from another program such as an Application Program Interface (API). Furthermore, alternative software implementations may be used including, but not limited to, distributed processing or component/object distributed processing, parallel processing, or virtual machine processing can also be constructed to implement the tools described herein.

In a networked deployment, the computer system may operate in the capacity of a server or as a client user computer in a server-client user network environment, or as a peer computer system in a peer-to-peer (or distributed) network environment. The computer system 1700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1700 can be implemented using electronic devices that provide voice, video or data communication. Further, while a single computer system 1700 is illustrated, the term “system” shall also be taken to include any collection of systems or sub-systems that individually or jointly execute a set, or multiple sets, of instructions to perform one or more computer functions.

As illustrated in FIG. 17, the computer system 1700 may include a processor 1702, e.g., a central processing unit (CPU), a graphics processing unit (GPU), or both. Moreover, the computer system 1700 can include a main memory 1704 and a static memory 1706 that can communicate with each other via a bus 1708. As shown, the computer system 1700 may further include a video display unit 1710, such as a liquid crystal display (LCD), an organic light emitting diode (OLED), a flat panel display, a solid state display, or a cathode ray tube (CRT). Additionally, the computer system 1700 may include an input device 1712, such as a keyboard, and a cursor control device 1714, such as a mouse. The computer system 1700 can also include a disk drive unit 1716, a signal generation device 1718, such as a speaker or remote control, and a network interface device 1720.

In a particular embodiment, as depicted in FIG. 17, the disk drive unit 1716 may include a computer-readable medium 1722 in which one or more sets of instructions 1724, e.g. software, can be embedded. Further, the instructions 1724 may embody one or more of the methods or logic as described herein. In a particular embodiment, the instructions 1724 may reside completely, or at least partially, within the main memory 1704, the static memory 1706, and/or within the processor 1702 during execution by the computer system 1700. The main memory 1704 and the processor 1702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1724 or receives and executes instructions 1724 responsive to a propagated signal, so that a device connected to a network 1726 can communicate voice, video or data over the network 1726. Further, the instructions 1724 may be transmitted or received over the network 1726 via the network interface device 1720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

We claim:

1. A method for deploying a network architecture, the method comprising:
deploying a first stage of the network architecture; and
deploying a second stage of the network architecture, where the second stage is deployed from the first stage, and where a total deployment across the first stage and the second stage of deployment is determined together before the first stage is deployed.

2. The method of claim 1, where the total deployment across the first stage and the second stage is determined using a dynamic program.

3. The method of claim 2, where the dynamic program comprises a program for determining future stages as a function of previous stages.

4. The method of claim 2, further comprising:
deploying a third stage of the network architecture, where the third stage is deployed from the second stage, and where a total deployment across the first stage, the second stage and the third stage of deployment is determined together before the first stage is deployed.

5. The method of claim 4, where the deployment from the first stage through the third stage is tailored to a demand profile but deployment of at least one of the first stage, the second stage, and the third stage separately is not tailored to the demand profile.

6. The method of claim 1, where the network architecture comprises communication links.

7. The method of claim 6, where the communication links comprise at least one of communication gear, communication lines, routers, switches and gateways.

8. The method of claim 1, where determining deployment comprises determining deployment cost.

9. A deployed network architecture, comprising:
a first stage of the deployed network architecture; and
a second stage of the deployed network architecture, where the second stage is deployed from the first stage, and where a total deployment across the first stage and the second stage of deployment is determined before the first stage is deployed.

10. The deployed network architecture of claim 9, where the total deployment across the first stage and the second stage is determined using a dynamic program.

11. The deployed network architecture of claim 9, where the first stage includes communication links and the second stage include communication links, where at least some of the communication links from the first stage are used in the second stage.

12. The deployed network architecture of claim 9, further comprising:
a third stage of the network architecture, where the third stage is deployed from the second stage, and where a total deployment across the first stage, the second stage and the third stage of deployment is determined together before the first stage is deployed.

13. The deployed network architecture of claim 9 where the total deployment across the first stage and the second stage comprises deployment cost.

14. A tool for determining a deployment of a network architecture, the tool comprising:
a program to collect data regarding expected future network demands;
a routine to determine a network configuration for a first stage of the network architecture in accordance with the data;
a routine to determine a network configuration for a second stage of the deployed network architecture in accordance with the data, where the second stage is deployed from the first stage; and
a routine to determine together a total deployment across the first stage and the second stage of deployment, before the first stage is deployed.

15. The tool of claim 14, where the routine is executed with a dynamic program.

16. The tool of claim 14, where the program to collect data comprises a spreadsheet.

17. The tool of claim 14, where network configuration of the first stage and the second stage comprises communication links.

18. The tool of claim 14, where the total deployment across the first stage and the second stage comprises deployment cost.

19. A software application stored in a computer-readable memory, the software application for determining a deployment of network architectures, comprising:
a routine to determine a network configuration for a first stage of the network architecture;
a routine to determine a network configuration for a second stage of the deployed network architecture in accordance with the data, where the second stage is deployed from the first stage; and
a routine to determine together a total deployment across the first stage and the second stage of deployment, before the first stage is deployed.

20. The software application of claim 19, where the routines comprise a dynamic program.

21. The software application of claim 19, where the total deployment across the first stage and the second stage comprise a deployment cost.
